(19) United States
(12) Patent Application Publication
(10) Pub. No.: US 2011/0165403 A1
(43) Pub. Date: Jul. 7, 2011

(54) PLY AND METHOD FOR THE METALLIZATION OF A PART MADE OF A COMPOSITE MATERIAL

(75) Inventor: Patrice Lefebure, Malakoff (FR)

(73) Assignee: EUROPEAN AERONAUTIC DEFENCE AND SPACE COMPANY EADS FRANCE, Paris (FR)

(21) Appl. No.: 13/055,484

(22) PCT Filed: Jul. 21, 2009
(86) PCT No.: PCT/EP2009/059352

§ 371 Date: Mar. 25, 2011

(30) Foreign Application Priority Data
Jul. 24, 2008 (FR) 0855078

(51) Int. Cl. B32B 15/08; B32B 5/28; B32B 27/06; B32B 27/04; B32B 37/02

(52) U.S. Cl. 428/220; 428/457; 428/433; 428/460; 428/458; 156/60

(57) ABSTRACT

A metallization ply (1) for the metallization of a thermoplastic composite material part (3), includes in the body thereof at least one substantially continuous metal layer (10) and at least one binding layer (11) secured to the metal layer and realized with a thermoplastic resin. A manufacturing method for a metallized thermoplastic composite material part (3) includes i) a step in which a structural ply or plies (20) are deposited forming a structural layer (2) of the part, ii) a step in which the metallization ply (1) is deposited on an outer face (2a) of the structural layer (2) with the binding layer (11) on the side of the outer face (2a) of the structural layer (2), and iii) a step in which the metallization ply (1) is consolidated with the structural layer (2). A metallized thermoplastic composite material part (3) is also described.

The present invention relates to the manufacture of composite material parts, and more particularly to the metallization of such parts aimed in particular at protection against lightning.

The use of composite materials is nowadays widespread in many industrial fields such as, for example, automobile, aircraft and building construction, in particular because of the weight gain that can be achieved in comparison with conventional materials with equivalent mechanical properties.

Composite materials comprising fibers, in particular long fibers, woven or not, mineral or organic, which are maintained by a high-performance thermosetting or thermoplastic organic resin matrix, are nowadays widely used in the manufacture of structural aircraft parts.

However, such composite materials, because they are usually electrically insulating or have low conductivity, exhibit poor behavior in cases of lightning strikes; this requires precautions for the manufacture of structural aircraft parts, which are directly exposed to the risk of lightning strikes.

To improve the intrinsic conductivity and resistance to lightning of high performance thermoplastic composite material parts, it is known to deposit on such a part a high electrical conductivity mesh, usually made of bronze, and to deposit a thermoplastic resin film over and possibly under said mesh. The resin film(s) and the structural layer are then consolidated through openings in the mesh by fusion of the thermoplastic resin film.

The structural layer is usually made by stacking plies comprising fibers impregnated with resin, which are arranged automatically using automatic ply depositing devices.

Automatic depositing of the plies is required in order to lower manufacturing costs and is also advantageous in some cases in order to meet the design specifications of certain parts, for example parts that are large and/or noninvolute i.e. having curvatures in two directions.

The metallization method described is difficult to implement automatically to manufacture such parts, in particular because of the mesh size and of noninvolute surfaces to be covered, and it is understood that new means are required for the automated manufacture of such parts.

The present invention proposes to solve the above problems by means of a metallization ply comprising in the body thereof at least one metal layer, characterized in that it comprises in the body a binding layer secured to the metal layer and realized with a thermoplastic resin and in that the metal layer is substantially continuous.

According to other characteristics of the metallization ply according to the invention:
the binding layer is reinforced by glass fibers, preferably representing between 10% and 30% by weight of the metallization ply,
the binding layer comprises mineral fillers, preferably representing between 1% and 5% by weight of the metallization ply,
the binding layer's thermoplastic resin is made of poly-ether-ether-ketone, poly-ether-ketone-ketone, or polyetherimide,
it is packaged in the form of a ribbon between 3 mm and 300 mm wide.

The invention also relates to a method of manufacturing a thermoplastic composite material part by depositing plies, the part comprising a structural layer made of composite material comprising fibers held by a thermoplastic resin matrix and a conductive layer on the side of an outer face of the structural layer. The method is characterized in that it comprises i) a step in which a structural ply or plies are deposited forming the structural layer, ii) a step in which the metallization ply according to the invention is deposited on the outer face of the structural layer with the binding layer on the side of the outer face of the structural layer, and iii) a step in which the metallization ply is consolidated with the structural layer.

According to other characteristics of the method according to the invention:
the metallization ply is deposited on the outer face of the structural layer in the form of hybrid ribbons arranged edge-to-edge along a preferred orientation,
the consolidation of each hybrid ribbon with the structural layer is carried out continuously at the same time as said hybrid ribbon is deposited,
each structural ply is deposited in the form of structural ribbons arranged edge-to-edge and the hybrid ribbons' widths are similar to those of the structural ribbons; preferably, the hybrid and structural ribbons are deposited with an automatic depositing device used to deposit the structural ribbons.

The invention also relates to a metallized thermoplastic composite material part comprising a metal layer and a structural layer made of composite material comprising fibers held by a thermoplastic resin matrix, characterized in that the metal layer is substantially continuous and in that the part comprises a binding layer made with a thermoplastic resin between the metal layer and the structural layer.

According to other characteristics of the part according to the invention:
the binding layer is reinforced by glass fibers, preferably representing between 10% and 30% by weight of the binding layer plus the metal layer,
the binding layer comprises mineral fillers, representing between 1% and 5% by weight of the binding layer plus the metal layer,
the thermoplastic resin of the structural layer is made of poly-ether-ether-ketone or poly-ether-ketone-ketone or polyetherimide, and
preferably the thermoplastic resin of the binding layer is of the same type as the matrix,
the fibers of the structural layer are long or continuous carbon fibers.

The following description of embodiments of the invention is made with reference to the figures, in which identical references denote identical or similar elements, showing, in a non-limiting way:

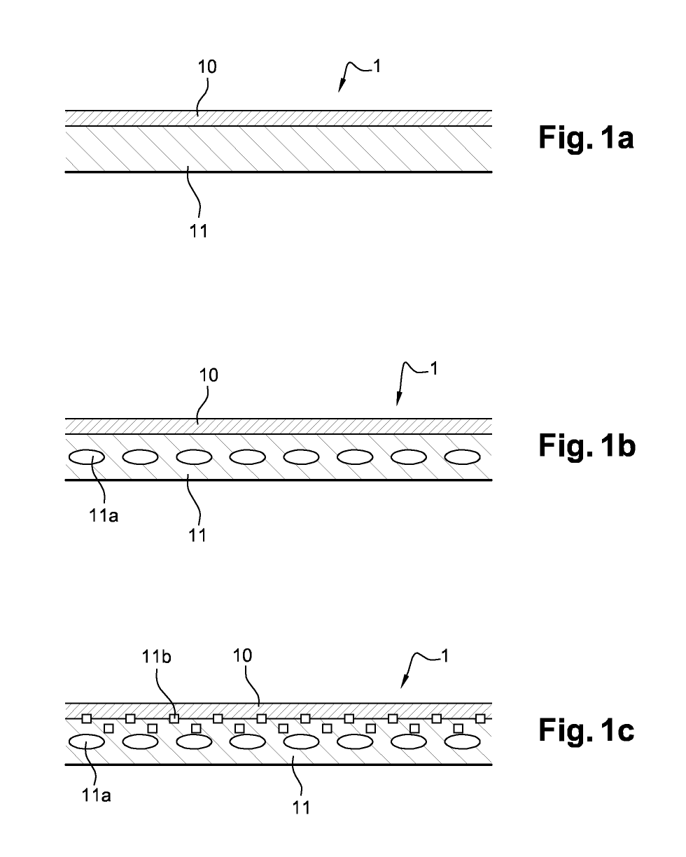

FIGS. 1a, 1b and 1c: schematic cross-section views of three embodiments of a metallization ply according to the invention,

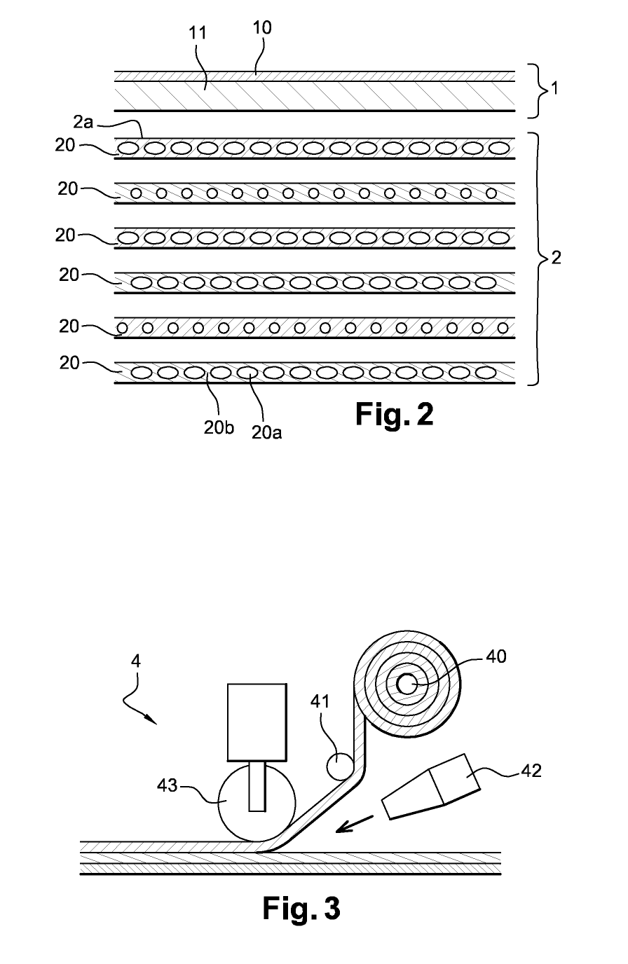

FIG. 2: schematic exploded cross-section view of the different layers of a metallized composite material part according to the invention,

FIG. 3: schematic diagram of an example device for continuously depositing and consolidating plies in the manufacture of a thermoplastic composite material,

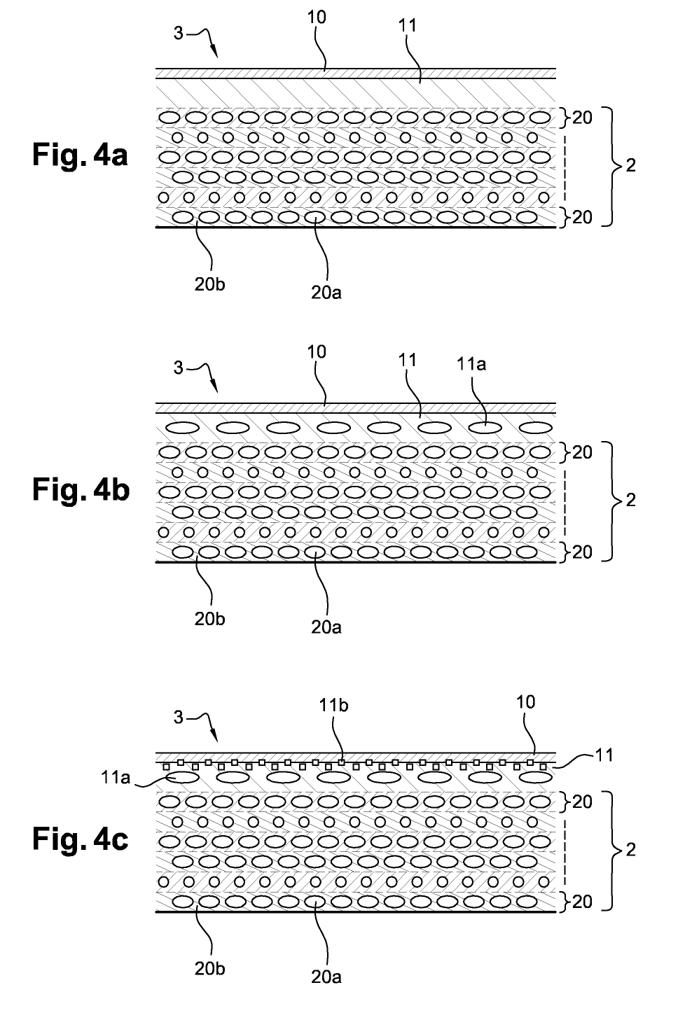

FIGS. 4a, 4b and 4c: schematic cross-section views of metallized composite material parts according to the invention.

The present invention relates to a hybrid metallization ply 1 of a composite material part 3, such as a structural part of an aircraft (airplane, helicopter, etc.) to be protected from the effects of lightning. The present invention also relates to a method of manufacturing the metallized composite material part 3 as well as said part.

The hybrid ply 1 according to the invention, shown schematically in FIG. 1a, is a thin sheet comprising in the body thereof two superposed and secured layers: a metal layer 10 and a binding layer 11. Preferably, the hybrid ply 1 consists only of the metal layer 10 and binding layer 11.

The metal layer 10, intended to be installed on the side of the part 3 most exposed to lightning, is substantially continuous and is preferably made of a material having good electrical conductivity per unit of mass, e.g. made of one or more aluminum or copper sheets.

“Substantially continuous” means that the metal layer 10 is uniform, i.e. that the thickness of the metal layer is substantially the same everywhere, unlike meshes used according to the state of art for the metallization of aircraft structures, which have substantially periodic openings. The metal layer 10 may in some cases, however, comprise openings, e.g. associated to openings in the part 3.

The binding layer 11 is made of a thermoplastic resin, preferably high performance, for example based on poly-ether-ether-ketone (PEEK), poly-ether-ketone-ketone (PEKK), polyetherimide (PEI), polyphenylene sulfide (PPS), etc.

In a preferred embodiment of the hybrid ply 1, shown in FIG. 1b, the binding layer 11 is reinforced with mineral fibers 11a. The mineral fibers 11a are preferably glass fibers, woven or arranged in felt, arranged substantially parallel to the metal layer 10, possibly in several sub-layers, or short fibers dispersed in the binding layer 11. The mineral fibers 11a reinforce the binding layer 11 in proportions ranging preferably from 10% to 30% by weight of the hybrid ply 1.

This embodiment is particularly advantageous because the hybrid ply 1 retains satisfactory flexibility, suitable for depositing onto the part 3 to be metallized, and because of increased stiffness and strength of said hybrid ply, thereby protecting the metal layer 10, in particular during depositing with automated devices. In addition, the use of glass fiber protects the metal layer 10 from possible galvanic corrosion associated, for example, with the presence of carbon fibers in the composite material part 3.

According to other variants, the binding layer 11 is reinforced with organic fibers, preferably electrically insulating, in the same proportions as in the case of mineral fibers 11a (between 10% and 30% by weight of the hybrid ply 1), such as aramid fibers (Kevlar®, etc.). In the rest of the description, only the case in which the binding layer 11 is reinforced with mineral fibers 11a is taken into consideration.

The binding layer 11 is secured to the metal layer 10, for example because of intrinsic adhesive properties.

In another preferred embodiment of the hybrid ply 1, shown in FIG. 1c, the binding layer 11 comprises mineral fillers 11b in the form of aggregates or “fillers”, preferably in proportions of 1% to 5% by weight of the hybrid ply 1.

The mineral fillers 11b are for example oxides containing titanium or zirconium, or any other type of mineral filler that improves the compatibility and adhesion between the binding layer 11 and the metal layer 10. The mineral fillers 11b are distributed at the interface between the binding layer 11 and the metal layer, and/or within said binding layer at least between the mineral fibers 11a and the metal layer 10; preferably the distribution is substantially uniform.

Because of the continuity of the metal layer 10, it is possible, for a given conductivity value, to produce a hybrid ply 1 whose thickness and grammage are significantly lower than those of a bronze mesh.

According to the invention, a thickness of the metal layer 10 below 50 μm (for example, from 10 μm to 20 μm) is possible for a conductivity equivalent to that of current bronze mesh.

The value of the thickness of the binding layer 11 is chosen in particular to obtain a minimum thickness of the hybrid ply 1 and ensure that said hybrid ply has a minimum level of damage resistance, in order to prevent the hybrid ply 1 from being damaged when deposited. The thickness of the binding layer 11 is for example from 50 μm to 150 μm.

Considering a copper metal layer 10, about 10 μm thick and a binding layer 11 made of PEEK-based high performance thermoplastic resin, about 50 μm thick, a grammage of about 150 to 180 g/m² is obtained depending on the type of the mineral fibers 11a and/or of the mineral fillers 11b of the binding layer 11; this is well below current grammage values obtained with bronze mesh consolidated with PEEK resin films (about 300 g/m² at least); this allows the manufacture of composite material parts weighing less than conventional metallized composite material parts.

Because of the thickness, strength and grammage obtained for the hybrid ply 1, automated depositing means can be used.

The hybrid ply 1 is, for example, rectangular, and advantageously presented in the form of a hybrid ribbon essentially characterized by its width, which can be packaged as a reel.

Preferably, the widths of the hybrid ribbons are narrower than the required dimensions of the part 3, which facilitates the metallization of large and/or noninvolute parts, and is compatible with automated depositing.

The width of the hybrid ribbons is for example adapted to the curvatures of the part 3 to be manufactured. For a noninvolute part 3, hybrid ribbons whose width is preferably between 3 mm and 30 mm are realized. For an involute part 3, hybrid ribbons whose width is between 150 mm and 300 mm, for example, are realized.

The hybrid ply 1 is suitable for the metallization of parts made of composite material comprising fibers maintained by an organic resin matrix. The hybrid ply 1 is used for the metallization of parts with which the thermoplastic resin matrix of the binding layer 11 is compatible, i.e. able to consolidate, by fusion for example, which is the case in particular for thermoplastic matrix parts, considering for example a binding layer 11 made of the same type of thermoplastic resin as the thermoplastic matrix of the part to be metallized.

In the rest of the description, the case of metallization of a thermoplastic composite material part 3 is considered.

The present invention also relates to a method of manufacturing the metallized thermoplastic composite material part 3, using the hybrid ply 1.

In a known first step of the manufacturing method, a structural layer 2 of part 3 is realized by depositing at least one structural ply 20 made of thermoplastic matrix composite material 20a reinforced with fibers 20b.

In the non-limiting example of FIG. 2, the structural layer 2 is formed by stacking a plurality of structural plies 20 in known manner. Said structural plies are preferably stacked on a mold, not shown, to give a desired shape to the structural layer 2 of the thermoplastic composite material part 3.

The fibers 20a of the structural plies 20 are for example carbon, glass, aramid, etc. fibers. The thermoplastic impregnation matrix 20b used in the structural plies 20 is preferably a high-performance thermoplastic resin, for example PEEK, PEKK, PPS, PEI, etc.—based.

In a preferred mode of implementation, the structural plies 20 comprise carbon fibers impregnated with PEEK-based resin, and said carbon fibers are long or continuous.

In a second step of the method according to the invention, the hybrid ply 1 according to the invention is deposited on an outer face 2a of the structural layer 2; said hybrid ply is deposited with the binding layer 11 on the outer face 2a side of the structural layer 2.

In a third step of the manufacturing method of the part 3, a consolidation of the hybrid ply 1 with the structural layer 2 is performed, i.e. said hybrid ply is secured onto the outer face 2a of the structural layer 2, using known methods of consolidation, such as, for example, a method of pressurization at high temperatures (usually above 300° C.) of the various layers, for example in an autoclave or vacuum oven, a method of continuous or “in place” depositing/consolidation (which will be described later), etc.

The various structural plies 20 forming the structural layer 2 are, for example, consolidated in the third step at the same time as the hybrid ply 1, for example in an autoclave or vacuum oven. In another non-limiting example, the structural plies 20 are consolidated in a prior step to firstly form the consolidated structural layer 2, the hybrid ply 1 being consolidated in the third step with the structural layer 2 previously independently consolidated.

When the structural plies 20 are consolidated in a prior step, consolidation is also performed either simultaneously for all the said structural plies, or for each ply in turn, consolidating each structural ply in place during depositing onto the structural ply or plies already deposited and consolidated, or by some other mode of consolidating the various structural plies.

In a particular mode of implementation of the method, the hybrid ply 1 is deposited in the form of hybrid ribbons arranged edge-to-edge, substantially parallel for example, and with or without an overlap between adjacent ribbons along a preferred orientation.

This particular mode is particularly advantageous when each structural ply 20 is deposited in the form of structural ribbons arranged edge-to-edge, substantially parallel, for example. Advantageously, the widths of the hybrid ribbons are similar to those of the structural ribbons, to facilitate depositing using the same method and the same automatic depositing device for both types of ribbon.

The consolidation of the various structural and hybrid ribbons is preferably a consolidation in place.

Consolidation in place is performed, for example with an automatic depositing and consolidation device 4 as shown schematically in FIG. 3, comprising for example a depositing head 40 on which a reel of structural or hybrid ribbon is placed. The reel is unwound through a guide 41 before depositing the ribbon. To deposit the ribbon, the ribbon and the plies already deposited are heated at their contact area, for example by means of a torch 42 blowing nitrogen at a temperature above the fusion temperature of the resin, or using other heating techniques such as laser heating, infrared etc.

The fusion of the thermoplastic resin ribbon and of a surface ply on which said ribbon is deposited, combined with pressure from a roller 43 on the ribbon at its contact surface with the plies already deposited, causes at least partial consolidation of the deposited ribbon with the surface ply.

Some depositing/consolidation settings of such a device 4 are adjustable: the heating temperature of the ribbon (adaptation to different types of resins), the pressure exerted by the roller 43, the depositing speed, etc.

In the case of a consolidation in place of the hybrid ply 1, the depositing/consolidation settings are preferably adjusted for the hybrid ribbon. In particular, the pressure exerted by the roller 43 is preferably adapted and/or adjusted to the resistance of the metal layer 10, as well as the depositing speed depending on the different types of resin to ensure effective consolidation.

The present invention also relates to a metallized thermoplastic composite material part 3, in particular such a part obtained by implementing the method described above, i.e. obtained after depositing the hybrid ply 1 and after consolidation of the different layers making up the part.

After consolidation, the part 3, shown schematically in cross-section in FIG. 4a, consists mainly of three secured layers:
a structural layer 2,
a metal layer 10,
a binding layer 11 between said structural layer and said metal layer.

The structural layer 2 is made of matrix composite material 20b made of fiber-reinforced thermoplastic resin 20a.

The fibers 20a of said structural layer 2 are for example carbon, glass, aramid, etc. fibers. The thermoplastic matrix 20b is preferably made of high-performance thermoplastic resin, for example PEEK, PEKK, PPS, PEI, etc.—based.

Preferably, the structural layer 2 comprises carbon fibers impregnated with high-performance thermoplastic resin and said carbon fibers are long or continuous, and can be arranged into several structural plies 20; the orientations of the carbon fibers may be different from one structural ply 20 to the next.

The metal layer 10 is essentially continuous and is preferably a sheet of aluminum or copper. The metal layer 10 may in some cases, comprise openings imposed by the shape of the part, e.g. associated to openings in the part 3.

The binding layer 11 comprises thermoplastic resin compatible with the thermoplastic matrix 20b forming the structural layer 2, preferably of the same type as the thermoplastic matrix 20b of the structural layer 2.

In another particular embodiment of the part 3, shown schematically in FIG. 4b, the binding layer 11 is reinforced with mineral fibers 11a. The mineral fibers 11a are, for example, glass fibers, woven or arranged in felt arranged substantially parallel to the metal layer 10, possibly in several sub-layers, or short fibers dispersed in the binding layer 11. The quantity of mineral fibers 11a reinforcing the binding layer 11 is preferably 10% to 30% by weight of the binding layer 11 plus the metal layer 10.

In another preferred embodiment of the part 3, shown in FIG. 4c, the binding layer 11 also comprises mineral fillers 11b, for example oxides comprising titanium or zirconium in aggregate form in proportions ranging preferably from 1% to 5% by weight of the binding layer 11 plus the metal layer 10. The mineral fillers are distributed at the interface between said binding layer 11 and the metal layer 10 and/or within the binding layer at least between the mineral fibers 11a and said metal layer.

The thickness of the metal layer 10 is preferably below 50 μm, for example between 10 μm and 20 μm and the thickness of the binding layer 11 is for example between 50 μm and 150 μm.

Protection of the metal layer 10 is for example ensured by one or more paint-type finishing layers on said metal layer of the part 3.

By using a hybrid ply comprising a substantially continuous thin metal layer and a reinforced binding layer, the invention allows the metallization of high-performance thermoplastic composite material parts with automatic depositing means, thereby reducing the manufacturing costs of said parts. Furthermore, it is possible to manufacture, with equivalent conductivity, parts weighing less than conventional metallized thermoplastic composite material parts, which is particularly advantageous for the manufacture of aircraft structural parts.

1. Metallization ply (1) for the metallization of a thermoplastic composite material part (3), said metallization ply comprising in the body thereof at least one metal layer (10) and being characterized in that it comprises in the body at least one binding layer (11) secured to said metal layer and realized with a thermoplastic resin, and in that the metal layer (10) is substantially continuous.

2. Metallization ply (1) according to claim 1, in which the binding layer (11) is reinforced by glass fibers (11a).

3. Metallization ply (1) according to claim 1, in which the binding layer (11) comprises mineral fillers (11b).

4. Metallization ply (1) according to claim 3, in which the glass fibers (11a) represent between 10% and 30% by weight of the metallization ply and/or mineral fillers (11b) represent between 1% and 5% by weight of the metallization ply (1).

5. Metallization ply (1) according to claim 1, in which the binding layer's (11) thermoplastic resin is made of poly-ether-ether-ketone, poly-ether-ketone-ketone, or polyetherimide.

6. Metallization ply (1) according to claim 1, substantially rectangular in shape, and between 3 mm and 300 mm wide.

7. Method of manufacturing a metalized thermoplastic composite material part (3) by depositing plies, part (3) to comprise a composite material structural layer (2) comprising fibers (20a) maintained by a matrix (20b) in thermoplastic resin and, on the side of an outer face (2a) of said structural layer, a conductive layer, said method being characterized in that it comprises:
a step in which a structural ply or plies (20) are deposited forming the structural layer (2),
a step in which a metallization ply (1) according to claim 1 is deposited on the outer face (2a) of the structural layer (2), said metallization ply being deposited with the binding layer (11) on the outer face (2a) side of the structural layer (2),
a step in which of the metallization ply (1) is consolidated with the structural layer (2).

8. Method according to claim 7, in which the metallization ply (1) is deposited on the outer face (2a) of the structural layer (2) in the form of hybrid ribbons arranged edge-to-edge along a preferred orientation.

9. Method according to claim 8, in which the consolidation of each hybrid ribbon with the structural layer (2) is carried out continuously at the same time as said hybrid ribbon is deposited.

10. Method according to claim 8, in which each structural ply (20) is deposited in the form of structural ribbons arranged edge-to-edge and in which the hybrid ribbons' widths are similar to those of the structural ribbons.

11. Method according to claim 10, in which the hybrid ribbons are deposited with an automatic depositing device (4) used to deposit the structural ribbons.

12. Metallized thermoplastic composite material part (3) comprising a metal layer (10) and a composite material structural layer (2) comprising fibers (20a) maintained by a matrix (20b) in thermoplastic resin, characterized in that said metal layer is substantially continuous and in that said part comprises a binding layer (11) made with a thermoplastic resin between the metal layer (10) and the structural layer (2).

13. Part (3) according to claim 12, in which the binding layer (11) is reinforced by glass fibers (11a).

14. Part (3) according to claim 12, in which the binding layer (11) comprises mineral fillers (11b).

15. Part (3) according to claim 14, in which the glass fibers (11a) represent 10% to 30% by weight of the binding layer (11) plus the metal layer (10) and/or the mineral fillers (11b) represent 1% to 5% by weight of the binding layer (11) plus the metal layer (10).

16. Part (3) according to, in which the thermoplastic resin of the structural layer (2) is made of poly-ether-ether-ketone or poly-ether-ketone-ketone or polyetherimide.

17. Part according to claim 16, in which the fibers (20a) of the structural layer (2) are long or continuous carbon fibers.

18. Part according to claim 16, in which the thermoplastic resin in the binding layer (11) is of the same type as the thermoplastic matrix (20b) of the structural layer.

19. Metallization ply (1) according to claim 2, in which the binding layer (11) comprises mineral fillers (11b).

20. Method according to claim 9, in which each structural ply (20) is deposited in the form of structural ribbons arranged edge-to-edge and in which the hybrid ribbons' widths are similar to those of the structural ribbons.
